(19) United States
(12) Patent Application Publication
(10) Pub. No.: US 2008/0276836 A1
(43) Pub. Date: Nov. 13, 2008

(54) Composition containing anti-misting component of reduced molecular weight and viscosity

(75) Inventors: David S. Schlitzer, Ballston Spa, NY (US); John A. Kilgour, Clifton Park, NY (US); Michael R. Pink, Stillwater, NY (US)

Correspondence Address: DILWORTH & BARRESE, LLP, 333 EARLE OVINGTON BLVD., SUITE 702, UNIONDALE, NY, 11553, US

(73) Assignee: Momentive Performance Materials Inc.

(21) Appl. No.: 11/801,383

(22) Filed: May 9, 2007

(51) Int. Cl. C08G 77/20; C08G 77/12

(52) U.S. Cl. 106/287.14

(57) ABSTRACT

The invention relates to compositions comprising (I) a silicone-based coating component susceptible to misting under mist-producing conditions; and (II) an anti-misting amount of at least one branched polysiloxane of reduced molecular weight and viscosity. The invention also relates to a process for coating a substrate with the above coating formulation, as well as hardened silicone-based coatings or films produced by subjecting the coated substrate to one or more curing steps.

### BACKGROUND OF THE INVENTION

1. Field of the Invention

The invention relates to a composition comprising a silicone-based coating component and a branched polysiloxane composition of reduced molecular weight and viscosity which is of particular use as mist suppressant in silicone-based release coatings.

2. Description of the Prior Art

It is well known that in operations where silicone-based paper release coating formulations are subjected to a high enough rotational or translational motion, e.g., in high speed roll coating of flexible supports and paper, misting and/or aerosoling can become significant problems. These problems become particularly significant when applying these release coatings at roll coating speeds approaching 1000 ft/min, while the trend in the paper coating industry is to use speeds in excess of 1500 ft/min, e.g., 2000-3000 ft/min. In addition to having a deleterious effect on manufacturing operations, these mist and aerosol particles present industrial hygiene and safety issues for those people operating or working in the vicinity of the coating equipment.

Specialized chemical formulations known generically as “mist suppressants” have commonly been used to reduce the formation of mist in such operations. These mist suppressants are typically branched polysiloxanes of high viscosity, e.g., typically greater than 1,500 centipoise (cPs), where 1cPs=1 millipascal-second (mPa·s). More typically, the viscosity of the branched polysiloxane is greater than 3,000 cPs or 5,000 cPs. In fact, it is common for the viscosity of the branched polysiloxane to be greater than 50,000 cPs

Though it has generally been found that such high viscosity branched polysiloxanes are highly effective mist suppressants, they suffer from the disadvantage of being difficult to handle and process precisely due to their high viscosities. For example, mixing the mist control agent (e.g., in a mixer with the mist-susceptible base formulation) is greatly impeded when using such high viscosity mist control agents. In fact, often, lower viscosity mist control agents are favored, due solely to the above-described technical constraint, over higher viscosity mist control agents, even though higher viscosity mist control agents are generally known to be more effective mist suppressants. Furthermore, lower viscosity mist control agents are preferred to maintain thin and consistent coatings on desired substrates.

Accordingly, there remains a need for mist suppressant compositions, which have at least the same or an improved capability of mist suppression while being easier to handle in transferring and mixing operations.

### SUMMARY OF THE INVENTION

These and other objectives have been achieved by providing a composition (i.e., coating formulation) comprising:

(I) a silicone-based coating component susceptible to misting under mist-producing conditions; and

(II) an anti-misting amount of a branched polysiloxane composition of reduced molecular weight and viscosity which comprises at least one member selected from the group consisting of:

i) branched fragmented polyorganosiloxane, the polysiloxane resulting from reacting under hydrosilylation reaction conditions a mixture comprising:
a) at least one compound containing on average at least two unsaturated sites per molecule, and
b) at least one polyorganosiloxane containing on average at least two silylhydride functional groups per molecule,
   provided, that at least one of (a) and/or (b) is fragmented by shearing prior to and/or during the hydrosilylation reaction and/or the polyorganosiloxane resulting from the hydrosilylation reaction is fragmented by shearing to provide the branched fragmented polyorganosiloxane;

ii) branched fragmented polyorganosiloxane, the polysiloxane resulting from equilibrating under equilibration conditions at least two polyoganosiloxanes selected the group consisting of cyclic, linear and branched polyorganosiloxanes, provided, that at least one polyorganosiloxane is fragmented by shearing prior to and/or during equilibrating and/or the polyorganosiloxane resulting from equilibration is fragmented by shearing to provide the branched fragmented polyorganosiloxane; and,

iii) branched fragmented polyorganosiloxane, the polysiloxane resulting from copolymerization under condensation conditions of at least one polyorganosiloxane containing at least two functional groups, provided, that at least one polyorganosiloxane is fragmented by shearing prior to and/or during copolymerization and/or the polyorganosiloxane resulting from copolymerization is fragmented by shearing to provide the branched fragmented polyorganosiloxane.

The invention is also directed to a coating process comprising applying to a substrate under mist-producing conditions the coating formulations described above. The coating formulation exhibits reduced misting when subjected to these mist-producing conditions as compared to the same composition lacking the anti-misting amount of branched polysiloxane composition of reduced molecular weight and viscosity.

The invention is also directed to a hardened silicone-based coating or film produced by subjecting a substrate coated with the coating formulations, as described above, to one or more curing steps.

The present invention advantageously provides paper release, adhesive, and related coating compositions containing novel branched polysiloxane mist suppressants of reduced molecular weight and viscosity. The coating compositions containing these mist suppressants are capable of significant reductions in misting during high speed coating operations while affording the additional benefits of being economical and simple to use and make.

### DETAILED DESCRIPTION OF THE INVENTION

The compositions of the invention contain, minimally, two components: (I) a silicone-based coating component susceptible to misting under mist-producing conditions; and (II) an anti-misting amount of a branched polysiloxane component of reduced molecular weight and viscosity (i.e., the anti-misting component).

The silicone-based coating component must be of such a flowable consistency that it can be applied to a substrate as a coating, e.g., by roll-coating, spraying, and the like. For example, the silicone-based coating component can be an uncured or partially cured liquid having a viscosity low enough so that it can be readily applied as a coating on a substrate. Typically, the silicone-based coating component has a viscosity below 1,500 centipoise (cPs), more typically in the range 50 to 1,000 cPs, and even more typically in the range 50 to 500 cPs, where 1 centipoise (cPs)=1 millipascal-second (mPa·s).

The silicone-based coating component can be directed to any application for which a silicone-based coating is useful, e.g., as release agents, lubricants, protectants, adhesives, and so on. A particularly suitable type of silicone-based coating component includes the well-known class of pressure-sensitive adhesives, which have the property of adhering to a surface and being easily removed therefrom without transferring more than trace quantities of the adhesive to the substrate surface.

For example, the silicone-based coating component can be any of the curable silicone coating or paper release compositions known in the art. Some examples of classes of curable silicone coating compositions are those which are curable by hydrosilylation reaction crosslinking, peroxide curing, photocuring (e.g., UV curing), and electron beam curing.

In one embodiment, the silicone-based coating component includes components capable of crosslinking under hydrosilylation reaction conditions, e.g., in the presence of a hydrosilylation catalyst, as further discussed below. The components capable of crosslinking under hydrosilylation reaction conditions include (i) one or more organosilicon compounds containing at least two unsaturated hydrocarbon functional groups per molecule, and (ii) one or more silylhydride-containing compounds containing at least two silylhydride functional groups per molecule. Some examples of unsaturated hydrocarbon groups of component (i) include vinyl, allyl, 3-butenyl, 4-pentenyl, 5-hexenyl, 6-heptenyl, 7-octenyl, 8-noneyl, 9-decenyl, 10-undecenyl, 4,7-octadienyl, 5,8-nonadienyl, and the like.

The unsaturated organosilicon compound of component (i) and the silylhydride-containing compound of component (ii) can be, independently, for example, a low molecular weight silane, disilane, trisilane, siloxane, disiloxane, trisiloxane, cyclotrisiloxane, or cyclotetrasiloxane compound, or the like, having either: at least two unsaturated hydrocarbon groups for the case of component (i), or at least two silylhydride functional groups for the case of component (ii). The examples given later on in this specification for each of these types of compounds for the anti-misting component apply here as well.

Alternatively, components (i) and/or (ii) can be any of the linear, branched, and/or crosslinked polymers having any two or more of a combination of M, D, T, and Q groups, wherein, as known in the art, an M group represents a monofunctional group of formula R₃SiO_{1/2}, a D group represents a bifunctional group of formula R₂SiO_{2/2}, a T group represents a trifunctional group of formula RSiO_{3/2}, and a Q group represents a tetrafunctional group of formula SiO_{4/2}, wherein the R groups can be any suitable groups including hydrogen, hydrocarbon (e.g., C₁-C₆), halogen, alkoxy, and/or amino groups, and wherein at least two of the R groups in the siloxanes described above are either: at least two unsaturated hydrocarbon groups for the case of component (i), or at least two silylhydride functional groups for the case of component (ii). Some examples of classes of polysiloxanes suitable for the silicone-based coating components include the MDM, TD, MT, MDT, MDTQ, MQ, MDQ, and MTQ classes of polysiloxanes, and combinations thereof, having either: at least two unsaturated hydrocarbon groups for the case of component (i), or at least two silylhydride functional groups for the case of component (ii).

For example, the silicone-based coating component can be a standard silicone paper release formulation containing 90-99% by weight of a vinylated polydimethylsiloxane polymer and 1-10% by weight of a silylhydride-functionalized siloxane-based compound or polymer based on the total weight of the silicone-based coating component, wherein each of the vinyl-containing and silylhydride-containing components typically has a viscosity in the range of about 20-500 cPs.

Typically, a catalyst inhibitor is included in the coating formulation in order to prevent curing of the catalyst during processing or to extend bath life or stability to the formulation during storage. The catalyst inhibitor can be any chemical known in the art which can inhibit the catalyst from curing during the coating process while not preventing curing when curing is desired. For example, the catalyst inhibitor can be a chemical which will sufficiently inhibit the catalyst from curing at room temperature during application of the coating formulation, but loses its inhibitory effect on being subjected to elevated temperatures when cure is desired. The inhibitor is typically included in the composition in an amount of about 5 to about 15 parts by weight of the composition. Some examples of catalyst inhibitors include maleates, fumarates, unsaturated amides, acetylenic compounds, unsaturated isocyanates, unsaturated hydrocarbon diesters, hydroperoxides, nitrites, and diaziridines.

The anti-misting component (i.e., the branched polysiloxane component) is included in the composition of the invention (i.e., the coating formulation) in an anti-misting amount. An anti-misting amount (mist suppressant amount) is an amount which causes a reduction in misting or aerosoling when the composition of the invention is used in a process which ordinarily causes misting or aerosoling of the composition. Typically, the anti-misting component is included in the coating formulation in an amount of about 0.1 to about 15 weight percent, and more typically, about 0.5 to about 5 weight percent of the coating formulation.

In one embodiment, a reduced molecular weight polysiloxane composition results from fragmenting a branched polysiloxane composition. The branched polysiloxane compositions of the invention results from reacting under hydrosilylation reaction conditions, a mixture of: a) at least one compound containing on average at least two unsaturated sites per molecule, and b) at least one polyorganosiloxane containing on average at least two silylhydride function groups per molecule. Provided, that at least one of (a) and/or (b) is fragmented by shearing prior to and/or during the hydrosilylation reaction and/or the polysiloxane resulting from the hydrosilylation reaction is fragmented by shearing to provide the branched fragmented polyorganosiloxane.

According to another embodiment of the invention, the branched polysiloxane composition of reduced molecular weight and viscosity results from equilibrating under equilibration conditions at least two polyoganosiloxanes selected the group consisting of cyclic, linear and branched polyorganosiloxanes. Provided, that at least one of the polyorganosiloxane is fragmented by shearing prior to and/or during equilibrating and/or the equilibrated polyorganosiloxane is fragmented by shearing to provide the branched fragmented polyorganosiloxane.

According to yet another embodiment of the invention, the branched polysiloxane composition of reduced molecular weight and viscosity results from copolymerization under condensation conditions of at least one polyorganosiloxanes containing at least two functional groups. Provided, that at least one of the polyorganosiloxane is fragmented by shearing prior to and/or during copolymerization and/or the copolymerized polyorganosiloxane is fragmented by shearing to provide the branched fragmented polyorganosiloxane.

In another embodiment of the invention, the branched polysiloxane composition of reduced molecular weight and viscosity results from reacting under hydrosilylation reaction conditions, a mixture of: a) at least one polyorganosiloxane containing on average at least two unsaturated sites per molecule, and b) at least one polyorganosiloxane containing on average at least two silylhydride function groups per molecule. Provided, that at least one of (a) and/or (b) is fragmented by shearing prior to and/or during the hydrosilylation reaction and/or the polysiloxane resulting from the hydrosilylation reaction is fragmented by shearing to provide the branched fragmented polyorganosiloxane.

In yet another embodiment of the invention, the branched polysiloxane composition of reduced molecular weight and viscosity results from copolymerization under condensation conditions at least one polyorganosiloxane containing at least two functional groups and a compound having at least two functional groups capable of reacting with the functional groups of the polyorganosiloxane. Provided, that at least one of the polyorganosiloxane and/or the compound is fragmented by shearing prior to and/or during copolymerization and/or the copolymerized polyorganosiloxane is fragmented by shearing to provide the branched fragmented polyorganosiloxane.

As used herein, the term “fragmenting” or “fragmented” refers to the breaking of molecular (i.e., chemical) bonds in the branched polysiloxane and/or in one or both of the components from which the branched polysiloxane is derived. Fragmenting can be achieved by any means known in the art. In a particular embodiment, fragmenting is achieved by applying an appropriate shear force, by one or more shear processing steps, on the branched polysiloxane and/or one of the components from which the branched polysiloxane is derived.

Any means capable of generating an amount of shear force sufficient for breaking chemical bonds can be useful for fragmenting according to the present invention. A fragmenting shear force is more typically provided by use of but not limited to a high-speed mixer, high-shear mixer, homogenizer, kneader, mill or extruder. The speed, agitation rate, or screw rate of the equipment must be high enough to cause at least some fragmentation while not rendering the branched polysiloxane substantially ineffective as a mist suppressant. An extruder screw rate of between 75 rpm and 500 rpm has been found to be particularly effective.

The viscosity of the branched polysiloxane before fragmenting is typically greater than 1,500 centipoise (cPs), where 1cPs=1 millipascal-second (mPa·s). More typically, the viscosity of the branched polysiloxane is about or greater than 3,000 cPs, and even more typically about 5,000 cPs. In other embodiments, the viscosity of the non-fragmented branched polysiloxane can be about or greater than 10,000 cPs, 25,000 cPs, 50,000 cPs, 100,000 cPs, or a higher viscosity. By fragmenting, the viscosity is reduced to a desired level, such as, for example, slightly reduced (e.g., 80-95% of the original viscosity), moderately reduced (e.g., 50-80% of the original viscosity), or significantly reduced (e.g., 5-50% of the original viscosity).

It is most preferable to fragment polysiloxanes in the absence of a diluent. Lack of a diluent allows greater chain entanglement and fragmentation by the shearing apparatus. Diluents reduce the effectiveness of the shear induced fragmentation and thus are minimized or avoided. Higher viscosity diluents aid in fragmentation better than their lower viscosity analogs. Preferred diluents are miscible with the polysiloxane prior to fragmentation and have viscosities above 100 cSt at 25° C. Diluents may include but are not limited to the following: 1) organic compounds, 2) organic compounds containing a silicon atom, 3) mixtures of organic compounds, 4) mixtures of compounds containing a silicon atom, and 5) mixtures of organic compounds and compounds containing a silicon atom. Organic diluents can be, inert aliphatic hydrocarbons such as pentane, hexane, heptane or octane; aromatic hydrocarbons such as benzene, toluene or xylene; alicyclic hydrocarbons such as cyclopentane or cyclohexane; halogenated aliphatic or aromatic hydrocarbons such as dichloromethane, tetrachloroethylene, o-, m- or p-dichlorobenzene or chlorobenzene, and the like can be used

Branched polysiloxanes as defined herein are materials which are miscible or soluble in an appropriate medium or “good” solvent. Polysiloxane gels or elastomers are defined herein as materials that swell in an appropriate medium or “good” solvent. These materials, i.e., polysiloxane gels and elastomers, are not miscible or soluble in solvents. Specifically, the present invention is focused on the use of branched materials that behave more like liquids rather than gels or elastomers that behave more like solids. Branched polysiloxanes that contain gel are undesirable because insoluble particulates interfere with the coating integrity. The branched nature of the reduced molecular weight and viscosity polysiloxanes and subsequent chain entanglement provides the unique properties observed. Since gel proportionally consumes a larger amount of the branch points and the gel must be removed prior to use, the properties of the non-gel material are attenuated.

A critical aspect of this invention is the application of shear, substantial enough to break chemical bonds, during the polymerization. Shearing during the polymerization allows the product to maintain a liquid-like consistency. Reactions performed in the absence of shear will have higher viscosities and possibly gel, see Table 2. Application of shear during the polymerization is postulated to fragment the material keeping the crosslink density to very low levels.

In one embodiment of the invention, the reaction (i.e., hydrosilylation, equilibration and condensation) can be performed in the presence of a diluent. However, according to a specific embodiment of the invention, the reaction (i.e., hydrosilylation, equilibration and condensation) is performed in the absence of a diluent as this aids in better fragmentation of the intermediate polymer. Diluents are more appropriately added after the polymerization-fragmentation step.

Examples of compounds containing on average at least two unsaturated sites per molecule that are suitable for preparing the branched fragmented polyorganosiloxane resulting from reacting under hydrosilylation reaction conditions include, but are not limited to, unsaturated hydrocarbon containing compounds, e.g., organosilicon compounds containing at least two unsaturated hydrocarbon groups. The unsaturated hydrocarbon groups in the organosilicon compounds of (a) include any straight-chained, branched, or cyclic hydrocarbon groups having at least one carbon-carbon double or triple bond capable of reacting with a silylhydride group under hydrosilylation conditions. More typically, the unsaturated hydrocarbon group contains two to twelve carbon atoms. Some examples of unsaturated hydrocarbon groups include substituted and unsubstituted vinyl, allyl, 3-butenyl, butadienyl, 4-pentenyl, 2,4-pentadienyl, 5-hexenyl, 6-heptenyl, 7-octenyl, 8-nonenyl, 9 decenyl, 10-undecenyl, 4,7-octadienyl, 5,8-nonadienyl, 5,9-decadienyl, 6,11-dodecadienyl, 4,8-nonadienyl, cyclobutenyl, cyclohexenyl, acryloyl, and methacryloyl.

Other suitable compounds include materials capable of undergoing a hydrosilylation reaction, such as, for example olefins. Some examples of specific olefins include, but are not limited to: 1,2,4-trivinylcyclohexane, 1,3,5-trivinylcyclohexane, 3,5-dimethyl-4-vinyl-1,6-heptadiene, 1,2,3,4-tetravinylcyclobutane, methytrivinylsilane, tetravinylsilane, and 1,1,2,2-tetraallyloxyethane, and the like.

Some examples of low molecular weight siloxane compounds suitable for use in preparing branched fragmented polysiloxane resulting from reacting under hydrosilylation reaction conditions include divinyldimethoxysilane, divinyldiethoxysilane, trivinylethoxysilane, diallyldiethoxysilane, triallylethoxysilane, vinyldimethylsiloxyvinyldimethylcarbinol (CH₂═CH₂—C(CH₃)₂—O—Si(CH₃)₂(CH₂═CH₂), 1,3-divinyltetramethyldisiloxane, 1,3-divinyltetraethyldisiloxane, 1,1-divinyltetramethyldisiloxane, 1,1,3-trivinyltrimethyldisiloxane, 1,1,1-trivinyltrimethyldisiloxane, 1,1,3,3-tetravinyldimethyldisiloxane, 1,1,1,3-tetravinyldimethyldisiloxane, 1,3-divinyltetraphenyldisiloxane, 1,1-divinyltetraphenyldisiloxane, 1,1,3-trivinyltriphenyldisiloxane, 1,1,1-trivinyltriphenyldisiloxane, 1,1,3,3-tetravinyldiphenyldisiloxane, 1,1,1,3-tetravinyldiphenyldisiloxane, hexavinyldisiloxane, tris(vinyldimethylsiloxy)methylsilane, tris(vinyldimethylsiloxy)methoxysilane, tris(vinyldimethylsiloxy)phenylsilane, and tetrakis(vinyldimethylsiloxy)silane.

Some examples of linear siloxane oligomers suitable for use in preparing the branched fragmented polysiloxane of the invention include 1,5-divinylhexamethyltrisiloxane, 1,3-divinylhexamethyltrisiloxane, 1,1-divinylhexamethyltrisiloxane, 3,3-divinylhexamethyltrisiloxane, 1,5-divinylhexaphenyltrisiloxane, 1,3-divinylhexaphenyltrisiloxane, 1,1-divinylhexaphenyltrisiloxane, 3,3-divinylhexaphenyltrisiloxane, 1,1,1-trivinylpentamethyltrisiloxane, 1,3,5-trivinylpentamethyltrisiloxane, 1,1,1-trivinylpentaphenyltrisiloxane, 1,3,5-trivinylpentaphenyltrisiloxane, 1,1,3,3-tetravinyltetramethyltrisiloxane, 1,1,5,5-tetravinyltetramethyltrisiloxane, 1,1,3,3-tetravinyltetraphenyltrisiloxane, 1,1,5,5-tetravinyltetraphenyltrisiloxane, 1,1,1,3,3-pentavinyltrimethyltrisiloxane, 1,1,3,5,5-pentavinyltrimethyltrisiloxane, 1,1,3,3,5,5-hexavinyldimethyltrisiloxane, 1,1,1,5,5,5-hexavinyldimethyltrisiloxane, 1,1,1,5,5,5-hexavinyldiphenyltrisiloxane, 1,1,1,5,5,5-hexavinyldimethoxytrisiloxane, 1,7-divinyloctamethyltetrasiloxane, 1,3,5,7-tetravinylhexamethyltetrasiloxane, and 1,1,7,7-tetravinylhexamethyltetrasiloxane.

Some examples of cyclic siloxane oligomers suitable for use in preparing the branched fragmented polysiloxane of the invention include 1,3-divinyltetramethylcyclotrisiloxane, 1,3,5-trivinyltrimethylcyclotrisiloxane, 1,3-divinyltetraphenylcyclotrisiloxane, 1,3,5-trivinyltriphenylcyclotrisiloxane, 1,3-divinylhexamethylcyclotetrasiloxane, 1,3,5-trivinylpentamethylcyclotetrasiloxane, and 1,3,5,7-tetravinyltetramethylcyclotetrasiloxane.

The polymeric siloxanes (polysiloxanes) suitable for use in preparing the branched fragmented polysiloxane of the invention include any of the linear, branched, and/or crosslinked polymers having any two or more of a combination of M, D, T, and Q groups, wherein, as known in the art, an M group represents a monofunctional group of formula R₃SiO_{1/2}, a D group represents a bifunctional group of formula R₂SiO_{2/2}, a T group represents a trifunctional group of formula RSiO_{3/2}, and a Q group represents a tetrafunctional group of formula SiO_{4/2}, and wherein at least two of the R groups are unsaturated hydrocarbon groups and the remainder of the R groups can be any suitable groups including hydrocarbon (e.g., C₁-C₆), halogen, alkoxy, ester, ether, alcohol, and/or acid groups.

Some examples of classes of polysiloxanes suitable for use in preparing the branched fragmented polysiloxane of the invention include the MDM, TD, MT, MDT, MDTQ, MQ, MDQ, and MTQ classes of polysiloxanes, and combinations thereof, having at least two unsaturated hydrocarbon groups.

In a particular embodiment, the polysiloxane suitable for use in preparing the branched fragmented polysiloxane of the invention is an MD-type of polysiloxane having one or more M and/or M^{vi} groups in combination with one or more D and/or D^{vi} groups, wherein M represents Si(CH₃)₃O—, M^{vi} represents (CH₂═CH)Si(CH₃)₂O—, D represents —Si(CH₃)₂O—, and D^{vi} represents —Si(CH═CH₂)(CH₃)O—, “vi” is an abbreviation for “vinyl,” and wherein the MD-type of polysiloxane contains at least two vinyl groups.

Other suitable MD-type polysiloxanes for use in preparing the branched fragmented polysiloxane of the invention include the M^{vi}DₙM^{vi}, M^{vi}D^{vi}ₙM, M^{vi}D^{vi}ₙDₘM, M^{vi}D^{vi}ₙM^{vi}, M^{vi}D^{vi}ₙDₘM^{vi}, MD^{vi}ₙM, and MD^{vi}ₙDₘM classes of MD-type polysiloxanes, wherein m and n each represent at least 1. Any one or combination of the foregoing types of MD polysiloxanes can be used for polyorganosiloxane of the invention. In various embodiments, m and n can independently represent, for example, a number within the ranges 1-10, 11-20, 50-100, 101-200, 201-500, 501-1500, and higher numbers.

The D^{vi} groups can also be randomly incorporated (i.e., not as a block) amongst D groups. For example, M^{vi}D^{vi}ₙDₘM can represent a polymer wherein n represents 5-20 and m represents 50-1500, and wherein the 5-20 D^{vi} groups are randomly incorporated amongst the 50-1500 D groups.

In another embodiment of the invention, the M^{vi} and D^{vi} groups can each independently include a higher number of unsaturated functional groups, such as, for example, (CH₂═CH)₂(CH₃)SiO— and (CH₂═CH)₃SiO— groups for M^{vi} or —Si(CH═CH₂)₂O— for D^{vi}.

The one or more silylhydride-containing compounds for use in preparing the branched fragmented polysiloxane of the invention include any low molecular weight compound, oligomer, or polymer containing at least two silylhydride functional groups per molecule. Suitable silylhydride-containing compounds for use in the present invention include siloxanes containing at least two silyhydride functional groups, dimethylsilane, diethylsilane, di-(n-propyl)silane, diisopropylsilane, diphenylsilane, methylchlorosilane, dichlorosilane, 1,3-disilapropane, 1,3-disilabutane, 1,4-disilabutane, 1,3-disilapentane, 1,4-disilapentane, 1,5-disilapentane, 1,6-disilahexane, bis-1,2-(dimethylsilyl)ethane, bis-1,3-(dimethylsilyl)propane, 1,2,3-trisilylpropane, 1,4-disilylbenzene, 1,2-dimethyldisilane, 1,1,2,2-tetramethyldisilane, 1,2-diphenyldisilane, 1,1,2,2-tetraphenyldisilane, 1,1,3,3-tetramethyldisiloxane, 1,1,3,3-tetraphenyldisiloxane, 1,1,3,3,5,5-hexamethyltrisiloxane, 1,1,1,5,5,5-hexamethyltrisiloxane, 1,3,5-trimethylcyclotrisiloxane, 1,3,5,7-tetramethylcyclotetrasiloxane, and 1,3,5,7-tetraphenylcyclotetrasiloxane, and the like.

Examples of silylhydride-containing oligomers and polymers of the invention include any of the linear, branched, and/or crosslinked polymers having any two or more of a combination of M, D, T, and Q groups, as described above, and having at least two silylhydride functional groups in the oligomer or polymer.

According to one embodiment of the invention, silylhydride-containing compounds for preparing the branched fragmented polysiloxane of the invention are an MD-type of polysiloxane having one or more M and/or M^{H} groups in combination with one or more D and/or D^{H} groups, wherein M represents Si(CH₃)₃O—, M^{H} represents HSi(CH₃)₂O—, D represents —Si(CH₃)₂O—, and D^{H} represents —Si(H)(CH₃)O—, and wherein the MD-type of polysiloxane contains at least two silylhydride groups.

Examples of suitable MD-type polysiloxanes include the M^{H}DₙM^{H}, M^{H}D^{H}ₙM, M^{H}D^{H}ₙDₘM, M^{H}D^{H}ₙM^{H}, M^{H}D^{H}ₙDₘM^{H}, MD^{H}ₙM, and MD^{H}ₙDₘM classes of MD-type polysiloxanes, and combinations thereof, wherein m and n each represent at least 1 and can have any of the numerical values as described above.

The D^{H} groups can also be randomly incorporated (i.e., not as a block) amongst D groups. For example, M^{H}D^{H}ₙDₘM can represent a polymer wherein n represents 5-20 and m represents 50-1500, and wherein the 5-20 D^{H} groups are randomly incorporated amongst the 50-1500 D groups.

In one embodiment, M^{H} and D^{H} groups can each independently have a higher number of silylhydride functional groups, such as, for example, H₂Si(CH₃)O— and H₃SiO— groups for M^{H} or —Si(H)₂O— for D^{H}.

Examples of siloxane-containing oligomers and polymers for preparing the branched fragmented polysiloxanes via equilibration of the invention include the linear, branched, and/or crosslinked polymers having any two or more of a combination of M, D, T, and Q groups, as described above in the oligomer or polymer.

In a particular embodiment of the invention, the siloxane used for equilibrating under equilibration conditions is an MD-type of polysiloxane having one or more M groups in combination with one or more D groups, wherein M represents Si(CH₃)₃O—, D represents —Si(CH₃)₂O—.

Examples of suitable MD-type polysiloxanes for equilibration include MDₙM, MDₙM, MDₙDₘM, MDₙM, MDₙDₘM, MDₙM, and MDₙDₘM classes of MD-type polysiloxanes, and combinations thereof, wherein m and n each represent at least 1 and can have any of the numerical values as described above.

Some examples of silylhalide-containing oligomers and polymers suitable for copolymerization under condensation conditions include any of the linear, branched, and/or crosslinked polymers having any two or more of a combination of M, D, T, and Q groups, as described above, and having at least two silylhalide functional groups in the oligomer or polymer. The halide present can be any suitable for condensation, for example, chloride, bromide, iodide or any mixture.

In a particular embodiment of the invention, the polyorganosiloxane used for copolymerzing under condensation conditions is the MD-type of polysiloxane having one or more M and/or M^{X} groups in combination with one or more D and/or D^{X} groups, wherein M represents Si(CH₃)₃O—, M^{X} represents XSi(CH₃)₂O—, D represents —Si(CH₃)₂O—, and D^{X} represents —Si(X)(CH₃)O—, and wherein the MD-type of polysiloxane contains at least two silylhalide groups. The X group being a halide suitable for condensation, for example, chloride, bromide, iodide or any mixture.

Examples of suitable MD-type polysiloxanes include the M^{X}DₙM^{X}, M^{X}D^{X}ₙM, M^{X}D^{X}ₙDₘM, M^{X}D^{X}ₙM^{X}, M^{X}D^{X}ₙDₘM^{X}, MD^{X}ₙM, and MD^{X}ₙDₘM classes of MD-type polysiloxanes, and combinations thereof, wherein m and n each represent at least 1 and can have any of the numerical values as described above.

The D^{X} groups can also be randomly incorporated (i.e., not as a block) amongst D groups. For example, M^{X}D^{X}ₙDₘM can represent a polymer wherein n represents 5-20 and m represents 50-1500, and wherein the 5-20 D^{X} groups are randomly incorporated amongst the 50-1500 D groups.

In other embodiments of the invention, M^{X} and D^{X} groups can each independently have a higher number of silylhalide functional groups, such as, for example, X₂Si(CH₃)O— and X₃SiO— groups for M^{X} or —Si(X)₂O— for D^{X}.

Examples of silanol-containing oligomers and polymers for use in preparing the branched fragmented polyorganosiloxane resulting from copolymerization under condensation conditions include any of the linear, branched, and/or crosslinked polymers having any two or more of a combination of M, D, T, and Q groups, as described above, and having at least two silanol functional groups in the oligomer or polymer.

The silanols can be homopolymers, copolymers or mixtures thereof. It is preferred that the silanol contain on average at least two organic radicals in a molecule per silicon atom. Examples of suitable silanols include hydroxyl end-blocked polydimethylsiloxane, hydroxyl end-blocked polydiorganosiloxane having siloxane units of dimethylsiloxane and phenylmethylsiloxane, hydroxyl end-blocked polymethyl-3,3,3-trifluoropropylsiloxane and hydroxyl end-blocked polyorganosiloxane having siloxane units of monomethylsiloxane, dimethylsiloxane, with the monomethylsiloxane units supplying “on-chain” hydroxyl groups. The silanol also includes mixtures of hydroxylated organosiloxane polymers, such as mixture of hydroxyl end-blocked polydimethylsiloxane and diphenylmethylsilanol.

In a particular embodiment of the invention, the polyorganosiloxane used in preparing the branched fragmented polyorganosiloxane resulting from copolymerization under condensation conditions is an MD-type of polysiloxane having one or more M and/or M^{OH} groups in combination with one or more D and/or D^{OH} groups, wherein M represents Si(CH₃)₃O—, M^{OH} represents HOSi(CH₃)₂O—, D represents —Si(CH₃)₂O—, and D^{OH} represents —Si(OH)(CH₃)O—, and wherein the MD-type of polysiloxane contains at least two silanol groups.

Examples of suitable MD-type polysiloxanes include the M^{OH}DₙM^{OH}, M^{OH}D^{OH}ₙM, M^{OH}D^{OH}ₙDₘM, M^{OH}D^{OH}ₙM^{OH}, M^{OH}D^{OH}ₙDₘM^{OH}, MD^{OH}ₙM, and MD^{OH}ₙDₘM classes of MD-type polysiloxanes, and combinations thereof, wherein m and n each represent at least 1 and can have any of the numerical values as described above.

The D^{OH} groups can also be randomly incorporated (i.e., not as a block) amongst D groups. For example, M^{OH}D^{OH}ₙDₘM can represent a polymer wherein n represents 5-20 and m represents 50-1500, and wherein the 5-20 D^{OH} groups are randomly incorporated amongst the 50-1500 D groups.

In yet another embodiment of the invention, M^{OH} and D^{OH} groups can each independently have a higher number of silanol functional groups, such as, for example, (HO)₂Si(CH₃)O— and(HO)₃SiO— groups for M^{OH} or —Si(OH)₂O— for D^{OH}.

Examples of alkoxysilane-containing oligomers and polymers for use in preparing the branched fragmented polyorganosiloxane resulting from copolymerization under condensation conditions include any of the linear, branched, and/or crosslinked polymers having any two or more of a combination of M, D, T, and Q groups, as described above, and having at least two alkoxysilane functional groups in the oligomer or polymer.

In a particular embodiment of the invention, the polyorganosiloxane used in preparing the branched fragmented polyorganosiloxane resulting from copolymerization under condensation conditions is an MD-type of polysiloxane having one or more M and/or M^{OR} groups in combination with one or more D and/or D^{OR} groups, wherein M represents Si(CH₃)₃O—, M^{OR} represents ROSi(CH₃)₂O—, D represents —Si(CH₃)₂O—, and DOR represents —Si(OR)(CH₃)O—, and wherein the MD-type of polysiloxane contains at least two alkoxysilanes wherein R may be independently chosen from methyl, ethyl, or propyl groups.

Examples of suitable MD-type polysiloxanes include the M^{OR}DₙM^{OR}, M^{OR}D^{OR}ₙM, M^{OR}D^{OR}ₙDₘM, M^{OR}D^{OR}ₙM^{OR}M^{OR}D^{OR}ₙDₘM^{OR}, MD^{OR}ₙM, and MD^{OR}ₙDₘM classes of MD-type polysiloxanes, and combinations thereof, wherein m and n each represent at least 1 and can have any of the numerical values as described above.

The D^{OR} groups can also be randomly incorporated (i.e., not as a block) amongst D groups. For example, M^{OR}D^{OR}ₙDₘM can represent a polymer wherein n represents 5-20 and m represents 50-1500, and wherein the 5-20 D^{OR} groups are randomly incorporated amongst the 50-1500 D groups.

In still another embodiment of the invention, M^{OR} and D^{OR} groups can each independently have a higher number of alkoxy functional groups, such as, for example, (RO)₂Si(CH₃)O— and (RO)₃SiO— groups for M^{OR} or —Si(OR)₂O— for D^{OR}.

Examples of silylester-containing oligomers and polymers the used in preparing the branched fragmented polyorganosiloxane resulting from copolymerization under condensation conditions include any of the linear, branched, and/or crosslinked polymers having any two or more of a combination of M, D, T, and Q groups, as described above, and having at least two silylester functional groups in the oligomer or polymer. Wherein the R group of the ester moiety is 1 to 6, 7 to 12, 13 to 30 carbon monovalent hydrocarbon radical, e.g., methyl, ethyl, propyl, iso-propyl, n-butyl, iso-butyl, sec-butyl, tert-buty, pentyl, hexyl, heptyl, phenyl, benzyl, and mesityl.

According to one embodiment of the invention, the polyorganosiloxane used in preparing the branched fragmented polyorganosiloxane resulting from copolymerization under condensation conditions is an MD-type of polysiloxane having one or more M and/or M^{O(CO)R} groups in combination with one or more D and/or D^{O(CO)R} groups, wherein M represents Si(CH₃)₃O—, M^{O(CO)R} represents R(CO)OSi(CH₃)₂O—, D represents —Si(CH₃)₂O—, and D^{O(CO)R} represents —Si(O(CO)R)(CH₃)O—, and wherein the MD-type of polysiloxane contains at least two silylester groups wherein R may contain between 1-6, 7-12, 13-30 carbon atoms.

Examples of suitable MD-type polysiloxanes include the M^{O(CO)R}DₙM^{O(CO)R}, M^{O(CO)R}D^{O(CO)R}ₙM, M^{O(CO)RD}D^{O(CO)R}ₙDₘM, M^{O(CO)R}D^{O(CO)R}ₙM^{O(CO)R}, M^{O(CO)R}D^{O(CO)R}ₙDₘM^{O(CO)R}, MD^{O(CO)R}ₙM, and MD^{O(CO)R}ₙDₘM classes of MD-type polysiloxanes, and combinations thereof, wherein m and n each represent at least 1 and can have any of the numerical values as described above.

The D^{O(CO)R} groups can also be randomly incorporated (i.e., not as a block) amongst D groups. For example, M^{O(CO)R}D^{O(CO)R}ₙDₘM can represent a polymer wherein n represents 5-20 and m represents 50-1500, and wherein the 5-20 D^{O(CO)R} groups are randomly incorporated amongst the 50-1500 D groups.

In another embodiment of the invention, M^{O(CO)R} and D^{O(CO)R} groups can each independently have a higher number of silylester functional groups, such as, for example, (R(CO)O)₂Si(CH₃)O— and (R(CO)O)₃SiO— groups for M^{O(CO)R}or —Si(O(CO)R)₂O— for D^{O(CO)R}.

According to another embodiment of the invention, when preparing the branched polysiloxane composition of the invention, the number of unsaturated sites per molecule of compound (a) (alternatively, the number of functional groups possessed by compound(a)) and the number of silylhydride functional groups per polyorganosiloxane (b) can vary in any combination to each other so long as there are at least two per molecule, respectively. Furthermore, the number of functional groups per polyorganosiloxane(s) and compound(s) undergoing copolymerization under condensation conditions can vary in any combination to each other so long as there are at least two per molecule, respectively.

For example, compound (a) can have two, or any number unsaturated sites per molecule while polyorganosiloxane (b) can have the same or different number of functional groups per molecule and are in any molar ratio with respect to each other, including equal or similar molar amounts. Similarly, the polyorganosiloxane(s) and compound(s) undergoing copolymerization under condensation conditions can contain an equal or different number of functional groups and are in any molar ratio with respect to each other, including equal or similar molar amounts provided that the polyorganosiloxane and compound each have at least two functional groups per molecule.

In yet another embodiment, the branched polysiloxane follows a branching pattern similar to a star polymer wherein when either compound (a) or polyorganosiloxane (b) has a higher number unsaturated sites or functional groups, respectively, (i.e., crosslinkers) they are present in a lower molar amount than the molecule of either compound (a) or polyorganosiloxane (b)having a lower number of unsaturated sites or functional groups, respectively, (i.e., extenders). As such, the above-described star polymer pattern is distinct from a dendritic pattern in which branching predominates.

For example, (a) or (b) can have at least four, five, six, seven, eight, nine, ten, or a higher number of unsaturated sites/functional groups, respectively, and be in a lower molar amount than (a) or (b) containing two or three unsaturated sites/functional groups, respectively, per molecule.

The unsaturated sites of compound (a) can be in any suitable molar ratio to silylhydride functional groups of polyorganosiloxane (b), e.g., 100:1, 50:1, 25:1, 20:1, 10:1, 1:10, 1:20, 1:25, 1:50, 1:100, and any range of ratios therebetween. Likewise, the functional groups of polyorganosiloxane(s) undergoing copolymerization under condensation conditions with a compound(s) having at least two functional groups can be in any suitable molar ratio, e.g., 100:1, 50:1, 25:1, 20:1, 10:1, 1:10, 1:20, 1:25, 1:50, 1:100, and any range of ratios therebetween.

In a particular embodiment, the unsaturated sites of compound (a) are in a molar ratio to silylhydride functional groups of polyorganosiloxane (b) within a range according to the formula (6-s):1 or 1 :(1+t) wherein s represents a number equal to or greater than 0 and less than 5, and t represents a number greater than 0 and equal to or less than 5. Some examples of such molar ratios of unsaturated sites of compound (a) to functional groups of polyorganosiloxane (b) include 6:1, 5.5:1, 5:1, 4.5:1, 4:1, 3.5:1, 3:1, 2.5:1, 2:1, 1.5:1, 1.4:1, 1.2:1, 1:1.2, 1:1.4, 1:1.5, 1:2, 1:2.5, 1:3, 1:3.5, 1:4, 1:4.5, 1:5, 1:5.5, and 1:6, and any range of ratios therebetween. The ratios within the range according to the formula (6-s):1 or 1 :(1+t) can apply to the functional groups of polyorganosiloxane(s) and compound(s) undergoing copolymerization under condensation conditions as well and can be depicted by the examples of molar ratios described herein, i.e., 6:1, 5.5:1, 5:1, 4.5:1, 4:1, 3.5:1, 3:1, 2.5:1, 2:1, 1.5:1, 1.4:1, 1.2:1, 1:1.2, 1:1.4, 1:1.5, 1:2, 1:2.5, 1:3, 1:3.5, 1:4, 1:4.5, 1:5, 1:5.5, and 1:6, and any range of ratios therebetween.

For example, in one embodiment, the unsaturated sites of compound (a) are in a molar ratio to silylhydride functional groups of polyorganosiloxane (b) within a range according to the formula (4.6-s):1 or 1 :(1+s) wherein s represents a number greater than 0 and less than 3.6. In another embodiment, the unsaturated sites of compound (a) are in a molar ratio to silylhydride functional groups of polyorganosiloxane (b) within a range according to the formula (4.25-s):1 or 1 :(1+t) wherein s represents a number equal to or greater than 0 and less than 3.25, and t represents a number greater than 0 and equal to or less than 3.25. In yet another embodiment, the unsaturated sites of compound (a) are in a molar ratio to silylhydride functional groups of polyorganosiloxane (b) within a range of about 4.5:1 to about 2:1. The ratios within the ranges according to the formulae (4.6-s):1 or 1 :(1+s) wherein s represents a number greater than 0 and less than 3.6 and (4.25-s):1 or 1 :(1+t) wherein s represents a number equal to or greater than 0 and less than 3.25, and t represents a number greater than 0 and equal to or less than 3.25, apply to the functional groups of functional groups of polyorganosiloxane(s) and compound(s) undergoing copolymerization under condensation conditions as well.

The phrase “hydrosilylation conditions” is defined herein as the conditions known in the art for hydrosilylation reaction between compounds containing unsaturated groups and compounds containing silylhydride groups.

As known in the art, a hydrosilylation catalyst is required to promote or effect the hydrosilylation reaction between compound (a) and polyorganosiloxane (b) either during or after mixing of the components at a suitable temperature. The hydrosilylation catalyst typically contains one or more platinum-group metals or metal complexes. For example, the hydrosilylation catalyst can be a metallic or complexed form of ruthenium, rhodium, palladium, osmium, iridium, or platinum. More typically, the hydrosilylation catalyst is platinum-based. The platinum-based catalyst can be, for example, platinum metal, platinum metal deposited on a carrier (e.g., silica, titania, zirconia, or carbon), chloroplatinic acid, or a platinum complex wherein platinum is complexed to a weakly binding ligand such as divinyltetramethyldisiloxane. The platinum catalyst can be included in a concentration range of, for example, 1-100 ppm, but is more typically included in a concentration of about 5 to 40 ppm.

Equilibration and condensation conditions herein are those conditions known in the art for equilibration and condensation reactions, which optionally include the use of appropriate catalysts. A condensation reaction being defined as a reaction that produces a “condensate” molecule from the reaction of two functional groups. An equilibration reaction is redistribution of chain lengths based on kinetic and/or thermodynamics.

The equilibration catalysts of the present include: acids, bases, tetralkyl ammonium salts and the like. Examples include various metal hydroxides, i.e., sodium hydroxide, potassium hydroxide, cesium hydroxide, or an appropriate silanolate, (i.e., the product of silanol and hydroxide). Acids may include any strong acid such as sulfuric, hydrochloric, hydrobromic, linear phosphonitirilic chloride (LPNC), ethylsulfuric, chlorosulfonic, selenic, nitric, phosphoric, pyrophosphoric, and boric acid. Acids can also be present as supported catalysts on solid supports such as fullers' earth and the like. Lewis acids are also effective for equlibrations: iron (III) chloride, aluminum (III) chloride, iron (III) oxide, boron trifluoride, zinc chloride and tin (IV) chloride.

Condensation catalysts contemplated herein include various tin (IV) compounds that are soluble in the medium. For example dibutyltindilaurate, dibutyltindiacetate, dibutyltindimethoxide, tinoctoate, isobutyltintriceroate, dibutyltinoxide, dibutyltin bis-diisooctylphthalate, bis-tripropoxysilyl dioctyltin, dibutyltin bis-acetylacetone, silylated dibutyltin dioxide, carbomethoxyphenyl tin tris-uberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, and tinbutyrate. In one embodiment, tin compounds and (C₈H₁₇)₂SnO dissolved in (n-C₃H₉O)₄Si are used. In another embodiment, diorganotin β-diketonates are used. Other examples of tin compounds may be found in U.S. Pat. No. 5,213,899, U.S. Pat. No. 4,554,338, U.S. Pat. No. 4,956,436, and U.S. Pat. No. 5,489,479, the teachings of which are herewith and hereby specifically incorporated by reference. In yet another embodiment, chelated titanium compounds, for example, 1,3-propanedioxytitanium bis(ethylacetoacetate); di-isopropoxytitanium bis(ethylacetoacetate); and tetra-alkyl titanates, for example, tetra n-butyl titanate and tetra-isopropyl titanate, are used.

Other examples of condensation catalysts include titanium compounds such as tetrabutyl titanate, titanium diisopropoxy-bis-ethylacetoacetate, and tetraisopropoxy titanate; carboxylates of bismuth; carboxylates of lead; carboxylates of zirconium; amines such as triethylamine, ethylenetriamine, butylamine, octylamine, dibutylamine, monoethanolamine, diethanolamine, triethanolamine, diethylenetriamine, triethylenetetramine, cyclohexylamine, benzylamine, diethylaminopropylamine, xylylenediamine, triethylenediamine, guanidine, diphenylguanidine, and morpholine.

In one embodiment, tetravalent SiO_{4/2}groups (i.e., Q groups) are excluded from the branched polysiloxane composition.

In another embodiment, unsaturated hydrocarbon compounds, such as, e.g., alpha-olefins, are excluded from the component mixture from which the branched polysiloxane is derived. Some examples of such unsaturated hydrocarbon compounds include alpha-olefins of the formula CH₂═CHR¹ wherein R¹ is selected from halogen, hydrogen, or a heteroatom-substituted or unsubstituted hydrocarbon group having one to sixty carbon atoms. Some heteroatoms include oxygen (O) and nitrogen (N) atoms.

In yet another embodiment, oxy-substituted hydrocarbon compounds, such as oxyalkylene-containing and/or ester-containing saturated or unsaturated compounds, are excluded from the branched polysiloxane composition.

Auxiliary and other components can be included, as necessary, to the component mixture for making the above-described branched polysiloxanes of reduced molecular weight and viscosity. Some types of auxiliary components include catalyst inhibitors, surfactants, and diluents. Some examples of catalyst inhibitors for addition polymerizations (i.e., hydrosilylations) include maleates, fumarates, unsaturated amides, acetylenic compounds, unsaturated isocyanates, unsaturated hydrocarbon diesters, hydroperoxides, nitrites, amines, and diaziridines. Some examples of diluents include the hydrocarbons (e.g., pentanes, hexanes, heptanes, octanes), aromatic hydrocarbons (e.g., benzene, toluene, and the xylenes), ketones (e.g., acetone, methylethylketone), and halogenated hydrocarbons (e.g., trichloroethene and perchloroethylene).

In another aspect, the invention is directed to a coating process wherein the coating formulation of the invention is applied to a substrate under conditions wherein misting or aerosoling of the coating formulation is known to occur. During such mist-producing conditions, the coating formulation of the invention will exhibit reduced misting as compared to the coating formulation without the anti-misting amount of branched polysiloxane.

The coating formulation can be applied, for example, by roll-coating, or alternatively, by spraying from a suitable applicator (e.g., a nozzle), wherein the applicator can be still or moving with respect to the substrate. Though misting or aerosoling is often caused predominantly by movement of the applicator with respect to a substrate, misting or aerosoling can be caused by factors other than movement of the applicator or substrate. For example, misting can be caused partially or predominantly by the method of application rather than by any motion of the applicator relative to the substrate, e.g., in a stationary or slow spraying process.

The coating process of the invention is particularly suitable for processes in which the coating formulation is being applied to a substrate in motion wherein the motion is the primary cause of the misting or aerosoling. The motion can be any kind of motion capable of causing misting or aerosoling, e.g., mist-producing levels of translational and/or rotational motion.

The substrate can be any substrate on which a coating of the above coating formulation is desired. Some examples of suitable substrates include paper, cardboard, wood products, polymer and plastic products, glass products, and metal products.

In another aspect, the invention is directed to a hardened (i.e., cured) coating obtained by hardening or curing the above coating formulation after its application on a substrate. The coating formulation, once applied to a substrate, can be cured by any suitable curing method known in the art, including, for example, hydrosilylation reaction crosslinking, peroxide curing, photocuring (e.g., UV curing), and electron beam curing.

The hardened coating can, if desired, be removed from the substrate in such cases where the coating, absent the substrate, is itself a useful product, e.g., for use as an appliable film. To aid in the separation of coating the hardened film from the substrate, a release additive can be included in the coating formulation, or a release film applied between the substrate and coating formulation.

Examples have been set forth below for the purpose of illustration. The scope of the invention is not to be in any way limited by the examples set forth herein.

Examples 1-18, displayed in Table 2, are representative coating formulations containing the mist suppressants according to the present invention.

The fragmented branched polysiloxane mist suppressants compositions of the coating formulations of Examples 1-18 were prepared with the following components:

Component (A) refers to a dimethylvinylsiloxy-terminated polydimethylsiloxane polymer having an average degree of polymerization of ca. 110 and a viscosity of ca. 250 centipoise.

Component (B) refers to a methylhydrogensiloxane polymer having a total average degree of polymerization of ca. 510 of which ca. 170 ppm hydride is present on the siloxane chain with a viscosity of ca. 8,200 centipoise.

Component (C) refers to Karstedt's catalyst diluted in Component A such that ca. 700 ppm Pt was present.

Component (D) refers to a diluting amount of Component (A).

Eighteen fragmented branched polysiloxane mist suppressants compositions (label Ex.1-18 in Table 1) were prepared for use in the coating formulations of Coating Examples 1-18 as follows: Component (A) and Component (B) were first pumped into a static mixer maintained at ambient temperature. The mixed polymer stream was added to the first barrel of a 30 mm co-rotating twin screw extruder. Component (C) was added to the extruder and the mixture conveyed through the extruder at a rate and temperature sufficient for a reaction to occur and viscosity to increase. The screw speed was maintained at about 450 rpm. The reaction mixture was diluted with Component (D).

Table 1 summarizes the reagents used, reaction conditions, and final product properties of the eighteen fragmented branched polysiloxane mist suppressants compositions that were used in the preparation of Coating Examples 1-18.

TABLE 1

| Ex. | Weight Parts of | | | | Reaction | | Shear Modulus |
|---|---|---|---|---|---|---|---|
| # | A | B | C | D | Vi:H | Temp | (@ 12 Hz, Pa) |
| 1 | 41.5 | 15.0 | 0.8 | 133.7 | 3.75 | 150 | 29 |
| 2 | 47.0 | 15.0 | 0.9 | 69.5 | 4.25 | 150 | 82 |
| 3 | 47.0 | 15.0 | 0.9 | 213.6 | 4.25 | 150 | 11 |
| 4 | 52.5 | 15.0 | 1.0 | 36.9 | 4.75 | 150 | 73 |
| 5 | 54.9 | 15.0 | 1.0 | 78.3 | 4.96 | 150 | 24 |
| 6 | 41.5 | 15.0 | 0.8 | 30.9 | 3.75 | 150 | 169 |
| 7 | 47.0 | 15.0 | 0.9 | 24.2 | 4.25 | 150 | 134 |
| 8 | 39.2 | 15.0 | 0.8 | 60.7 | 3.54 | 150 | 134 |
| 9 | 52.5 | 15.0 | 1.0 | 159.9 | 4.75 | 150 | 11 |
| 10 | 44.2 | 15.0 | 3.4 | 125.9 | 4.0 | 120 | 49 |
| 11 | 44.2 | 15.0 | 0.9 | 125.9 | 4.0 | 150 | 28 |
| 12 | 44.2 | 15.0 | 3.4 | 39.5 | 4.0 | 120 | 252 |
| 13 | 22.1 | 15.0 | 2.2 | 78.9 | 2.0 | 150 | 192 |
| 14 | 44.2 | 15.0 | 0.9 | 39.5 | 4.0 | 150 | 132 |
| 15 | 44.2 | 15.0 | 3.4 | 39.5 | 4.0 | 150 | 133 |
| 16 | 66.4 | 15.0 | 1.2 | 0.0 | 6.0 | 140 | 36 |
| 17 | 44.2 | 15.0 | 0.9 | 40.1 | 4.0 | 140 | 152 |
| 18 | 66.4 | 15.0 | 1.2 | 0.0 | 6.0 | 140 | 39 |

The silicone-based coating formulation was the same for each of the Coating Examples 1-18 except that each Coating Example contained one of the mist suppressants listed in Table 1, i.e., Coating Examples 1-18 of Table 2 contained mist suppressants Ex. 1-18 of Table 1, respectively. The coating formulations for Coating Examples 1-18 were prepared as follows: to a two-gallon plastic pail was charged with 92 parts (1840 g) of a commercially available M^{Vi}D₁₁₀M^{Vi} solution (containing 100 ppm Pt and 0.4% diallylmaleate inhibitor) and 5 parts (100 g) of a commercially available M^{Vi}D₁₁₀M^{vi} solution (containing 1000 ppm Pt and 0.4% diallylmaleate inhibitor). The anti-mist composition was charged to the pail in the amount of 3 parts (60g) and mixed with a drill-mounted agitator. The crosslinker, a commercially available hydride (MD₃₀D^{H}₁₅M) was added to the pail in the amount of 6 parts (120g). The mixture was mixed thoroughly with a drill-mounted agitator. Comparative Example 1 was prepared in a similar fashion but the anti-mist composition was eliminated and an additional 3 parts (60g) of commercially available M^{Vi}D₁₁₀M^{Vi} solution (containing 100 ppm Pt and 0.4% diallylmaleate inhibitor) was added.

The mist suppression ability of the silicone-based coating formulations of Coating Examples 1-18 and Comparative Example 1 was determined by roll coating the coating formulations using an 18-inch wide, five-roll pilot coater at line speeds from 1,500-3,000 feet per minute onto Nicolet NG241 paper or equivalent. The target coat weight was 0.6-0.9 pounds per ream. Mist was measured using Model 8520 DustTrak Aerosol Monitor manufactured by TSI Corporation. The monitor was positioned where the highest concentration of mist was visually perceived.

Table 2 below summarizes the aerosol or mist-suppression performance of the above described coating formulations. Table 2 clearly shows the efficacy of the mist suppression additives within this invention compared to the control formulations.

TABLE 2

| | Weight | | |
|---|---|---|---|
| | Percent Mist | | |
| | Suppressant | Line | |
| | in Silicone | Speed | Mist |
| Examples | Coating | ft/min | mg/m³ |
| Comparative | 0 | 2000 | 66.9 |
| Example 1 | | | |
| Example 1 | 3.0 | 3000 | 3.7 |
| Example 2 | 3.0 | 3000 | 2.2 |
| Example 3 | 3.0 | 3000 | 4.1 |
| Example 4 | 3.0 | 3000 | 2.0 |
| Example 5 | 3.0 | 3000 | 3.5 |
| Example 6 | 3.0 | 3000 | 1.4 |
| Example 7 | 3.0 | 3000 | 1.2 |
| Example 8 | 3.0 | 3000 | 2.9 |
| Example 9 | 3.0 | 3000 | 4.7 |
| Example 10 | 3.0 | 3000 | 1.4 |
| Example 11 | 3.0 | 3000 | 2.8 |
| Example 12 | 3.0 | 3000 | 1.5 |
| Example 13 | 3.0 | 3000 | 36.1 |
| Example 14 | 3.0 | 3000 | 2.1 |
| Example 15 | 3.0 | 3000 | 0.8 |
| Example 16 | 3.0 | 3000 | 3.6 |
| Example 17 | 3.0 | 3000 | 1.2 |
| Example 18 | 3.0 | 3000 | 3.3 |

Thus, whereas there have been described what are presently believed to be the preferred embodiments of the present invention, those skilled in the art will realize that other and further embodiments can be made without departing from the spirit of the invention, and it is intended to include all such further modifications and changes as come within the true scope of the claims set forth herein.

1. A composition comprising:
(I) a silicone-based coating component susceptible to misting under mist-producing conditions; and
(II) an anti-misting amount of a branched polysiloxane composition of reduced molecular weight and viscosity which comprises at least one member selected from the group consisting of:
i) branched fragmented pplyorganosiloxane, the polysiloxane resulting from reacting under hydrosilylation reaction conditions a mixture comprising:
a) at least one compound containing on average at least two unsaturated sites per molecule, and
b) at least one polyorganosiloxane containing on average at least two silylhydride functional groups per molecule,
provided, that at least one of (a) and/or (b) is fragmented by shearing prior to and/or during the hydrosilylation reaction and/or the polyorganosiloxane resulting from the hydrosilylation reaction is fragmented by shearing to provide the branched fragmented polyorganosiloxane;
ii) branched fragmented polyorganosiloxane, the polysiloxane resulting from equilibrating under equilibration conditions at least two polyoganosiloxanes selected from the group consisting of cyclic, linear and branched polyorganosiloxanes, provided, that at least one polyorganosiloxane is fragmented by shearing prior to and/or during equilibrating and/or the polyorganosiloxane resulting from equilibration is fragmented by shearing to provide the branched fragmented polyorganosiloxane; and,
iii) branched fragmented polyorganosiloxane, the polysiloxane resulting from copolymerization under condensation conditions of at least one polyorganosiloxane containing at least two functional groups, provided, that at least one polyorganosiloxane is fragmented by shearing prior to and/or during copolymerization and/or the polyorganosiloxane resulting from copolymerization is fragmented by shearing to provide the branched fragmented polyorganosiloxane.

2. The composition of claim 1 wherein compound (a) is at least one polyorganosiloxane containing on average at least two unsaturated sites per molecule.

3. The composition of claim 1 wherein branched fragmented polyorganosiloxane iii) results from copolymerization under condensation conditions of at least one polyorganosiloxane containing at least two functional groups and at least one compound with at least two functional groups, provided, that at least one polyorganosiloxane and/or compound is fragmented by shearing prior to and/or during copolymerization and/or the copolymerized polyorganosiloxane is fragmented by shearing to provide the branched fragmented polyorganosiloxane.

4. The composition of claim 1 wherein at least one of compound (a) or polyorganosiloxane (b) contains at least six functional groups per molecule.

5. The composition of claim 3 wherein at least one of the polyorganosiloxane or compound contains at least six functional groups per molecule.

6. The composition of claim 1 wherein at least one of compound (a) or polyorganosiloxane (b) has more functional groups than the other and is present in a molar amount equal to or lower than the molar amount of the other.

7. The composition of claim 3 wherein at least one of the polyorganosiloxane or compound has more functional groups than the other and is present in a molar amount equal to or lower than the molar amount of the other.

8. The composition of claim 1 wherein the unsaturated sites of (a) are in a molar ratio to silylhydride functional groups of (b) within a range of about (6-s):1 or about 1 :(1+t) where s represents a number equal to or greater than 0 and less than 5, and t represents a number greater than 0 and equal to or less than 5.

9. The composition of claim 3 wherein the functional groups of the polyorganosiloxane are in a molar ratio to the functional groups of the compound within a range of about (6-s):1 or about 1(1+t) where s represents a number equal to or greater than 0 and less than 5, and t represents a number greater than 0 and equal to or less than 5.

10. The composition of claim 1 wherein the unsaturated sites of (a) are in a molar ratio to silylhydride functional groups of (b) within a range according to a formula (4.6-s):1 or 1:(1+s) where s represents a number greater than 0 and less than 3.6.

11. The composition of claim 3 wherein the functional groups of polyorganosiloxane are in a molar ratio to the functional groups of the compound within a range according to a formula (4.6-s):1 or 1:(1+s) where s represents a number greater than 0 and less than 3.6.

12. The composition of claim 1 wherein the unsaturated sites of (a) are in a molar ratio to silylhydride functional groups of (b) within a range according to a formula (4.25-s):1 or 1:(1+t) where s represents a number equal to or greater than 0 and less than 3.25, and t represents a number greater than 0 and equal to or less than 3.25.

13. The composition of claim 3 wherein the functional groups of polyorganosiloxane are in a molar ratio to the functional groups of the compound within a range according to a formula (4.25-s):1 or 1:(1+t) where s represents a number equal to or greater than 0 and less than 3.25, and t represents a number greater than 0 and equal to or less than 3.25.

14. The composition of claim 1 wherein the unsaturated sites of (a) are in a molar ratio to silylhydride functional groups of (b) within a range according to a formula (4.6-s):1 where s represents a number greater than 0 and less than 3.6.

15. The composition of claim 3 wherein the functional groups of polyorganosiloxane are in a molar ratio to the functional groups of the compound within a range according to a formula (4.6-s):1 where s represents a number greater than 0 and less than 3.6.

16. The composition of claim 1 wherein the unsaturated sites of (a) are in a molar ratio to silylhydride functional groups of (b) within a range of about 4.5:1 to about 2:1.

17. The composition of claim 3 wherein the functional groups of polyorganosiloxane are in a molar ratio to the functional groups of the compound within a range of about 4.5:1 to about 2:1.

18. A coating process comprising applying to a substrate under mist-producing conditions the composition of claim 1, the composition exhibiting reduced misting when subjected to said mist-producing conditions as compared to the same composition lacking an anti-misting amount of branched polysiloxane composition of reduced molecular weight and viscosity.

19. A coating process comprising applying to a substrate under mist-producing conditions the composition of claim 2, the composition exhibiting reduced misting when subjected to said mist-producing conditions as compared to the same composition lacking an anti-misting amount of branched polysiloxane composition of reduced molecular weight and viscosity.

20. A coating process comprising applying to a substrate under mist-producing conditions the composition of claim 3, the composition exhibiting reduced misting when subjected to said mist-producing conditions as compared to the same composition lacking an anti-misting amount of branched polysiloxane composition of reduced molecular weight and viscosity.

21. A coating process comprising applying to a substrate under mist-producing conditions the composition of claim 4, the composition exhibiting reduced misting when subjected to said mist-producing conditions as compared to the same composition lacking an anti-misting amount of branched polysiloxane composition of reduced molecular weight and viscosity.

22. A coating process comprising applying to a substrate under mist-producing conditions the composition of claim 5, the composition exhibiting reduced misting when subjected to said mist-producing conditions as compared to the same composition lacking an anti-misting amount of branched polysiloxane composition of reduced molecular weight and viscosity.

23. A coating process comprising applying to a substrate under mist-producing conditions the composition of claim 6, the composition exhibiting reduced misting when subjected to said mist-producing conditions as compared to the same composition lacking an anti-misting amount of branched polysiloxane composition of reduced molecular weight and viscosity.

24. A coating process comprising applying to a substrate under mist-producing conditions the composition of claim 7, the composition exhibiting reduced misting when subjected to said mist-producing conditions as compared to the same composition lacking an anti-misting amount of branched polysiloxane composition of reduced molecular weight and viscosity.

25. A coating process comprising applying to a substrate under mist-producing conditions the composition of claim 8, the composition exhibiting reduced misting when subjected to said mist-producing conditions as compared to the same composition lacking an anti-misting amount of branched polysiloxane composition of reduced molecular weight and viscosity.

26. A coating process comprising applying to a substrate under mist-producing conditions the composition of claim 9, the composition exhibiting reduced misting when subjected to said mist-producing conditions as compared to the same composition lacking an anti-misting amount of branched polysiloxane composition of reduced molecular weight and viscosity.

27. A coating process comprising applying to a substrate under mist-producing conditions the composition of claim 10, the composition exhibiting reduced misting when subjected to said mist-producing conditions as compared to the same composition lacking an anti-misting amount of branched polysiloxane composition of reduced molecular weight and viscosity.

28. A hardened silicone-based coating or film produced by subjecting a substrate coated with the composition of claim 1 to one or more curing steps.
